(19) United States
(12) Patent Application Publication
(10) Pub. No.: US 2007/0124224 A1
(43) Pub. Date: May 31, 2007

(54) Method of money transfer using payroll deduction

(75) Inventors: Robbin L. Ayers, Greenwood Village, CO (US); Veronica Pedrotty, Alexandria, VA (US)

Correspondence Address: LEYENDECKER LEMIRE & DALEY, LLC, C/O PORTFOLIO IP, P.O. BOX 52050, MINNEAPOLIS, MN, 55402, US

(73) Assignee: Travelex Currency Services, Inc.

(21) Appl. No.: 11/289,745

(22) Filed: Nov. 29, 2005

(51) Int. Cl. G07C 1/10

(52) U.S. Cl. 705/32; 235/379

(57) ABSTRACT

Embodiments of methods for transferring money using a payroll deduction process is described. An employer acting as an agent for a licensed money transmitter deducts money an employee desires to transfer to an intended recipient from the employee's periodic compensation. A transfer request is processed with the licensed money transmitter over a secure network thereby making the money available to an intended recipient in a remote location at an agent of the licensed money transmitter. A unique transaction code is provided to the employer who then provides the unique transaction code to the employee typically with the employee's paycheck. The employee provides the unique transaction code to the intended recipient who can then pick up the money at the agent by tendering the unique transaction code.

### FIELD OF THE INVENTION

The present invention relates generally to the electronic transfer of currency from one location to another typically, although not necessarily, across international borders.

### BACKGROUND

Immigration to the United States by people from poor countries is relatively common in the United States. Further, there are many foreign workers who come to the United States with no intention of immigrating but to take advantage of our higher standard of living with the intent of someday returning to their home country. Often immigrants and foreign workers have family that remains in their home countries, and it is not uncommon for them to send money to their family members to assist them financially. There are numerous ways of sending money to those in other countries.

Currency can be sent directly to the intended recipients by way of a postal service; however, senders (senders is specifically defined below in the Terminology section) often don't trust their countries postal system fearing that the money will be removed from the package before reaching the intended recipients. In many cases, these fears are not unfounded.

Money can be wired from a United States bank account to a bank account of the intended recipient in the home country. However, senders often do not have and/or do not want bank accounts. Further, the intended recipients may also not have a bank account. In Mexico for instance, poorer citizens traditionally do not trust the banks and are often fearful that all or a portion of their money will be absconded by corrupt bank employees.

Money can be transferred electronically using a licensed money transmitter that operates independently of banks and therefore does not require the senders or their intended recipients to have bank accounts. This service is often advantageous to mailing money as the currency is also converted from dollars to whatever form used in the home country (such as Pesos in Mexico). Money transfer companies typically operate out of retail establishments that are signed as agents of a particular licensed money transmitter. Agents can include, but are not limited to, grocery stores, gas stations, liquor stores, mobile phone stores, drug stores and check cashing establishments. Agents in the home countries can also comprise retail establishments but may also comprise banking institutions.

A typical process involved in the transfer of currency from a sender in the United States to an intended recipient in another country is illustrated the block diagram of FIG. 1. As indicated in block 110, a sender receives his/her pay and/or paycheck from his/her employer. As an aside, the person transferring money to someone in another country need not be an immigrant or foreign worker; however, those transferring money to other countries usually are immigrants or foreign workers. Next, the sender cashes his/her paycheck either at a bank or if the sender does not have a bank account as is often the case, the sender will often cash his/her check at a check cashing service as indicated in block 120.

If the sender uses a check cashing service that is also a money transfer company agent, the check cashing service can handle the transfer of a portion of the money to the sender's home country (or any other desired country). However, if not, the sender must then travel to an agent of the money transfer company he uses as indicated in block 130. As mentioned above, typical money transfer company agents can comprise any number of different types of retail establishments. Further, in certain areas where there are a high number of senders that transfer currency back to their home countries, a money transfer company may have its own retail establishment.

As indicated in block 140, the sender provides the agent with the amount of money he/she desires to send to an intended recipient in the home country along with the required fees. Some money transfer companies charge (i) a flat fee per transaction up to a predetermined amount of money to be transferred, such as $10 for up to $1000, and (ii) a foreign exchange margin fee for the conversion of the currency from dollars to another form used in the home country. Other fees may also be assessed for additional services, such as but not limited to home delivery of the transferred money or bank deposit of the money. The agent typically earns a portion of the transaction fee in commission for initiating and handling the transaction.

Referring to block 150, the agent's representative keys in the transaction information into a terminal coupled with a secure network. The network can comprise a closed system or the network can utilize the internet and appropriate encryption algorithms to ensure the security and safety of the network. The information typically includes the sender's name, contact information, sender's address, the location and agent to which the money is to be sent. Information concerning the intended recipient is usually also be required.

The agent's representative then receives a unique transaction code (UTC) from the licensed money transmitter and a receipt. Upon the presentation of the UTC to the money transfer company' agent at the payout location, the intended recipient will be given the amount of money transferred by the sender. The money itself is not necessarily wired to the agent directly and normally, the money becomes available the second the UTC is issued. Rather, the money transfer company keeps track of the amounts due and owed each agent based on the transactions carried out at the various agent locations. Accordingly, on a periodic basis the necessary funds are debited or credited to the agents' accounts.

As indicated in block 170, the sender contacts the intended recipient of the currency and gives them the UTC along with the location at which the money can be picked up. The intended recipient then goes to the local money transfer agent provides the UTC and receives the money in the local form of currency as indicated in blocks 180 and 190.

While the money transfer system generally works effectively for both the users of the service and the service providers, competition has reduced the number of available agents for licensed money transmitter companies seeking to expand their operations. The retail sites currently not offering money transfer services in locations having large immigrant or foreign-born populations are typically not well suited to integrating money transfer services, and accordingly, there is a significant risk that these sites if signed as agents might not generate sufficient transaction revenues to make the expense of equipping the site with a secure terminal and training the employees of the agent cost effective. Furthermore, because of the competition for retail agent sites, the retail agents are able to play money transfer companies off against each other for a higher cut of the commissions. As the commission rates of the agents increase, the transaction fees charged to the users of the money transfer services also increase thereby reducing the amount of currency that ultimately ends up in the hands of the intended recipient.

### BRIEF DESCRIPTION OF THE DRAWINGS

FIG. 1 is a block diagram illustrating a prior art process of transferring money using a money transfer service.

FIG. 2 is a block diagram of a typical computer system that can be used with embodiments of the present invention.

FIG. 3 is a block diagram of an information network according to one embodiment of the present invention.

FIG. 4 is a flow chart illustrating a process of transferring money from an employee to an intended recipient in another country using payroll deductions according to one embodiment of the present invention.

FIG. 5a is the first page of a sample application that an employer would use to enroll in the money transfer service using payroll deductions for employees according to one embodiment of the present invention.

FIG. 5b is the second page of a sample application that an employer would apply to become an agent of the money transfer service to authorize the employer to initiate money transfers using payroll deductions of employees according to one embodiment of the present invention.

FIG. 6 is a sample enrollment form that an employee would use to sign up for the money transfer service according to one embodiment of the present invention.

FIG. 7 is a flow chart illustrating a process of transferring money from an employee to an intended recipient in another country using payroll deductions according to another embodiment of the present invention.

### DETAILED DESCRIPTION

In embodiments of the present invention, a method and system for transferring money from an employee of a company to another person are described. Typically, although not necessarily, the person receiving the money is located in another country. For purposes of this document, the exemplary embodiment(s) described herein will relate to a recipient located in Mexico, but it is to be understood that the invention as claimed is not intended to be limited only to transfers to Mexico or any other country. In fact, a similar process can be used to transfer money within the United States when one or both of the employee and the recipient do not have bank accounts.

The embodiments described and claimed herein facilitate the direct and regular transfer of money to the intended recipient. Further, according to embodiments described herein, the employee no longer has to cash his/her paycheck and then travel to a money transfer agent to send money to someone in another country. Because the desired and chosen amount of money is transferred automatically to the employee's intended recipient at regular intervals coinciding with the receipt of his/her paycheck and because the employee never sees or receives this money directly, the risk that the employee will spend the money impulsively, lose the money or have the money stolen before he/she can transfer it is eliminated. The paperwork that the employee would have to fill out each time he/she desires to transfer money using a retail agent is also eliminated.

In certain embodiments, the employer serves as the agent of the licensed money transmitter company that facilitates the actual transfer of funds, and like retail based agents, earns a commission for each transfer. The employer can use the commissions for any purpose it desires. The employer may use the commissions to offset the expense of administering the program and even to reduce other administrative costs associated with having employees. Additionally or alternatively, the employer may use the commissions to offset the money transfer fees assessed the employee thereby reducing the cost to transfer money to another country.

In certain variations, the transaction rates charged the employee can be discounted by the licensed money transmitter over what is available at retail agent locations. Further, the employee may be automatically enrolled in the money transfer companies frequent user program that further offers additional discounts on the transaction fees.

Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “embodiments”, “variations”, “a variation” and similar phrases means that a particular feature, structure, or characteristic described in connection with the embodiment(s) or variation(s) is included in at least an embodiment or variation of the invention. The appearances of the phrase “in one embodiment” or “in one variation” in various places in the specification are not necessarily all referring to the same embodiment or variation.

The terms “money” and “currency” are used throughout this document. In general, money is used to generically without regard to its specific type (i.e. dollars or pesos); whereas, currency is generally used to indicate a specific type of money. However, for the sake of the claims appended herein both terms should be considered interchangeable.

The term, “employer” as used herein refers broadly to any person or entity that pays others for performing services on its behalf. An “employee” is therefore any person who receives compensation or remuneration for performing a service on behalf of an employer. Accordingly, for sake of this document, an independent contractor doing work for another for a fee would be considered an employee of entity (employer) for whom he/she is performing the work.

The term “sender” as used herein refers to any user of a money transfer service, such as those offered by licensed money transmitters. Most typically, although not necessarily, senders are immigrants or foreign workers.

The term, “pay” as used herein refers to the payment of currency or other consideration to an employee by an employer for the performance of work and/or services typically in the form of a “paycheck”. While the entomology of the term, “paycheck” indicates a bank draft or check is tendered to an employee, as used herein, the term is also used to refer to cash or other types of payments tendered to an employee as payment for services rendered. The term “paycheck” also refers to a paystub that is given to an employee who has his/her pay directly deposited in a bank. A “paycheck” therefore typically, although not necessarily, includes an accounting of an employees periodic compensation and how the compensation amount has been allocated such as to taxes, benefits and other payroll deductions.

The term, “payroll deduction” as used herein refers to the deduction of a portion of an employee's pay from his/her paycheck and allocation and payment of the portion to another, such as a bank or licensed money transmitter.

The phrase “Licensed Money Transmitter” (also LMT) as used herein refers to any business or company that transfers money or currency from one location to another location for a fee on behalf of a person desiring the transfer. Most states require the licensing of companies that transfer money or currency.

An Exemplary Computer System

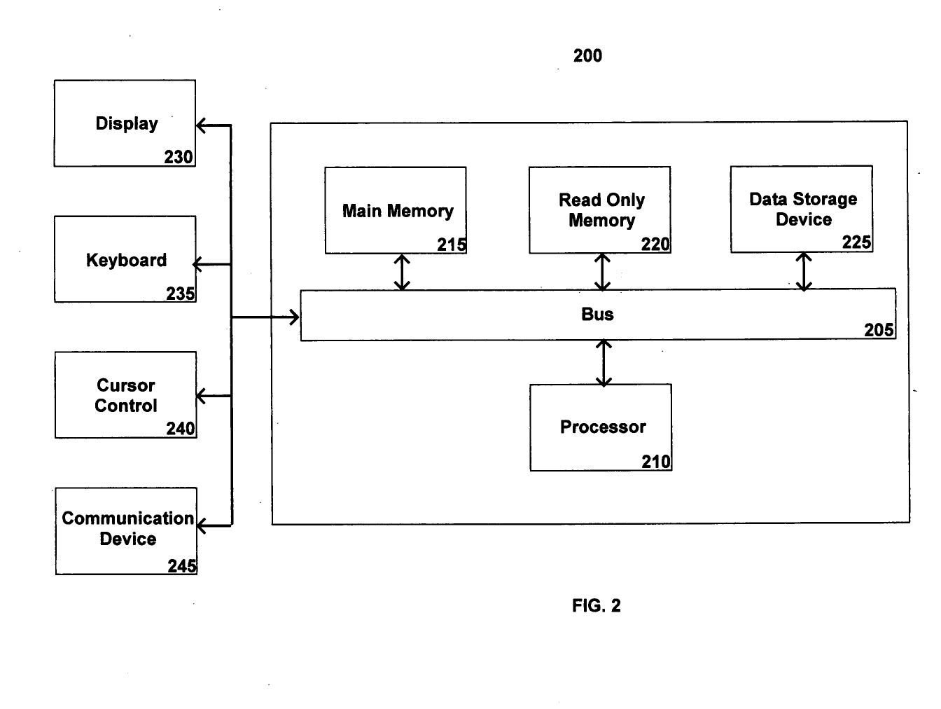

FIG. 2 illustrates an exemplary computer system 200 upon which embodiments of the invention may be implemented either as a server that facilitates the transfer of money between agents or as a terminal access point to a money transfer provider's secure network. The computer system comprises a bus 205 or other communication means for communicating information, and a processing means, such as a processor 210, coupled with the bus for processing information. The computer system further comprises a random access memory (RAM) or other dynamically-generated storage device 215 (referred to as main memory), coupled to the bus for storing information and instructions to be executed on by the processor. The main memory 215 may also be used for storing temporary variables or other intermediate information during execution of instructions by the processor. The computer system also typically comprises read only memory (ROM) 220 and/or another static storage device coupled to the bus 205 for storing static information and instructions for the processor.

A data storage device 225, such as a magnetic disk or optical disk and its corresponding drive or a flash memory storage device may also be coupled to the computer system 200 for storing information and instructions. The computer system can also be coupled via the bus 205 to a display device 230, such as a cathode ray tube (CRT) or Liquid Crystal Display (LCD), for displaying information to an end user. Typically, an alphanumeric input device (keyboard) 235, including alphanumeric and other keys, may be coupled to the bus for communicating information and/or command selections to the processor 210. Another common type of user input device is cursor control device 240, such as a mouse, a trackball, a trackpad or cursor direction keys for communicating direction information and command selections to the processor and for controlling cursor movement on the display.

A communication device 245 is also coupled to the bus 205. The communication device may include a modem, a network interface card, or other well-known interface devices, such as those used for coupling to Ethernet, token ring, or other types of physical attachment for purposes of providing a communication link to support a local or wide area network, for example. The communications device may also be a wireless device for coupling to a wireless network. In this manner, the computer system may be coupled to a number of clients and/or servers via a conventional network infrastructure, such as an Intranet of a licensed money transmitter and/or the Internet, for example.

It is appreciated that a lesser or more equipped computer system than the example described above may be desirable for certain implementations. Therefore, the configuration of computer system 200 will vary from implementation to implementation depending upon numerous factors, such as its intended use, price constraints, performance requirements, technological improvements, and/or other circumstances.

It should be noted that, while the operations described herein may be performed under the control of a programmed processor, such as processor 210, in alternative embodiments, the operations may be fully or partially implemented by any programmable or hard coded logic, such as Field Programmable Gate Arrays (FPGAs), TTL logic, or Application Specific Integrated Circuits (ASICs), for example. Additionally, the method of the present invention may be performed by any combination of programmed general-purpose computer components and/or custom hardware components. Therefore, nothing disclosed herein should be construed as limiting the present invention to a particular embodiment wherein the recited operations are performed by a specific combination of hardware components.

An Exemplary Network

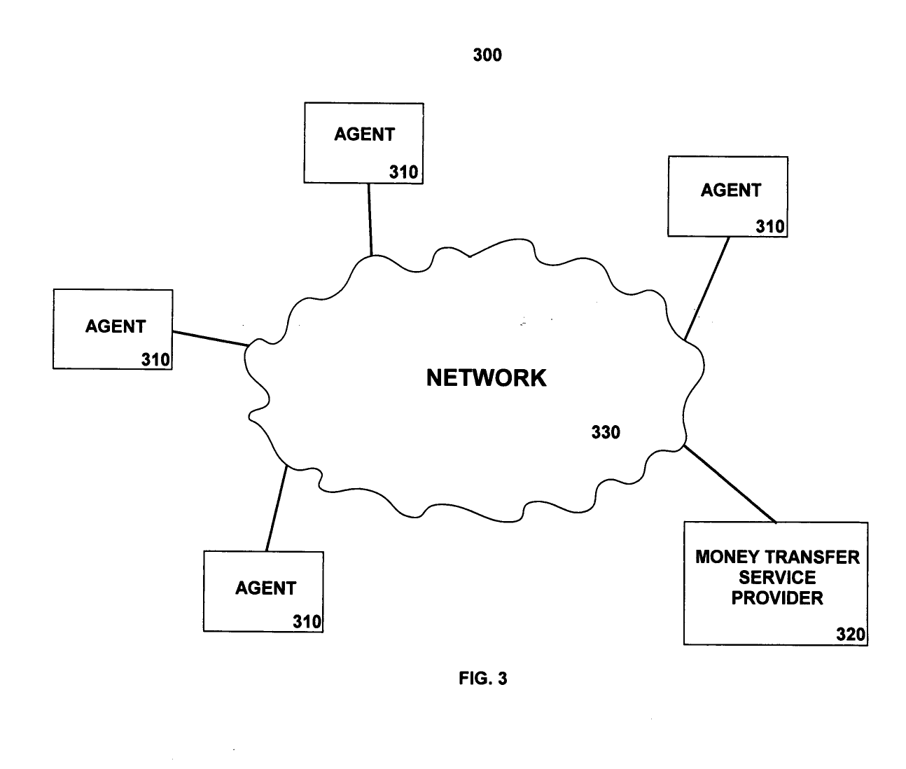

FIG. 3 illustrates an exemplary network that can be utilized with embodiments of the present invention may be implemented. Simply, the network comprises a plurality of agent terminals 310 and one or more servers 320 that are interconnected through a suitable network connection 330, such as the Internet or an intranet.

The server(s) 320 typically comprise variations of the exemplary computer system 200 as described above, and typically include associated software loaded on the respective computer systems to facilitate the communication and the transfer of data between the systems. The one or more servers are typically controlled by a licensed money transmitter (LMT) and include the necessary information concerning each agent in an associated database. The server facilitates the transfer of money from one agent location to another. The one or more servers can be coupled to other computers on the illustrated network connection 330 or another network connection altogether to third party servers and computer systems (not shown) for accessing and obtaining currency exchange rates and other information pertinent to the a money transfer. Typically, the unique transaction code (UTC) that is used be the intended recipient to pick up the transferred money is generated by a server of the one or more servers. Generally, the operation and functionality of the one or more servers are similar in embodiments and variations of the payroll deduction money transfer system and methodology described herein to the one or more servers used in a traditional prior art money transfer process. In fact, in certain embodiments, the same set of one or more servers can be used to process transactions from retail money transfer agents, as well as, employer agents. In other variations, the servers used for the payroll deduction money transfer process can be segregated from servers used for retail transactions.

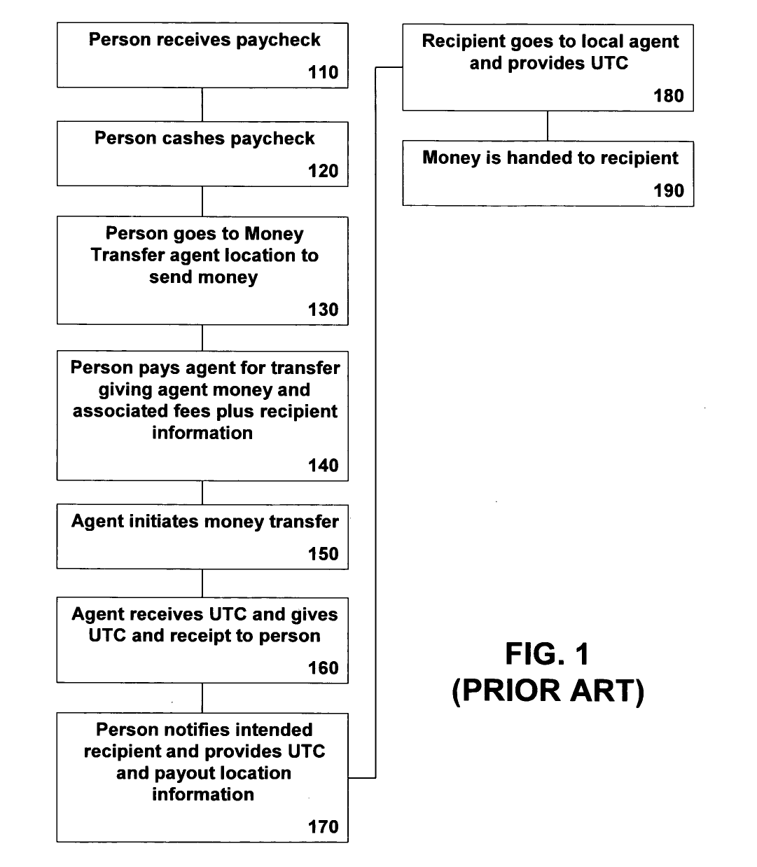

The agent terminals 310 typically comprise a computer system similar to those described above with reference to FIG. 1, although in some variations one or more of the terminals can be dumb terminals instead of computers. The agent terminals related to the payroll deduction process can be terminals located in a retail setting and terminals located within a company, such as in the human resources or payroll department. In one embodiment, the terminals used by retail agents are connected to the same servers 320 as the terminals used by retail agents by way of the same network connection 330.

The network connection 330 typically utilized in embodiments of the payroll deduction money transfer system as illustrated is the Internet. To ensure that the communications transferred over the Internet are secure encryption technologies that are well known in the art are utilized. Accordingly a virtual private network between the one or more servers 320 and the plurality of agent terminals 310 can be ensured. In variations, however, direct connection with an intranet can be utilized. For example, a terminal can include a modem wherein the terminal dials and connects with a server directly. With a direct connection using a traditional telephone line, the agent terminals would only be connected to the servers when one of a server and a particular terminal initiate and establish a temporary connection; normally the servers and the agent terminals would not be connected. The agent terminals can also be connected to the servers via wired always-on secure intranet connections and/or they can be connected using any suitable wireless technology. Ultimately, any number of means to connect the various agent terminals to the servers can be utilized. Since agents may be located at places all over the globe with some places being more developed technologically than others, a number of different means can be utilized with the same servers to provide connectivity to the network for different terminals.

A First Embodiment of a Process of Transferring Money Using Payroll Deduction

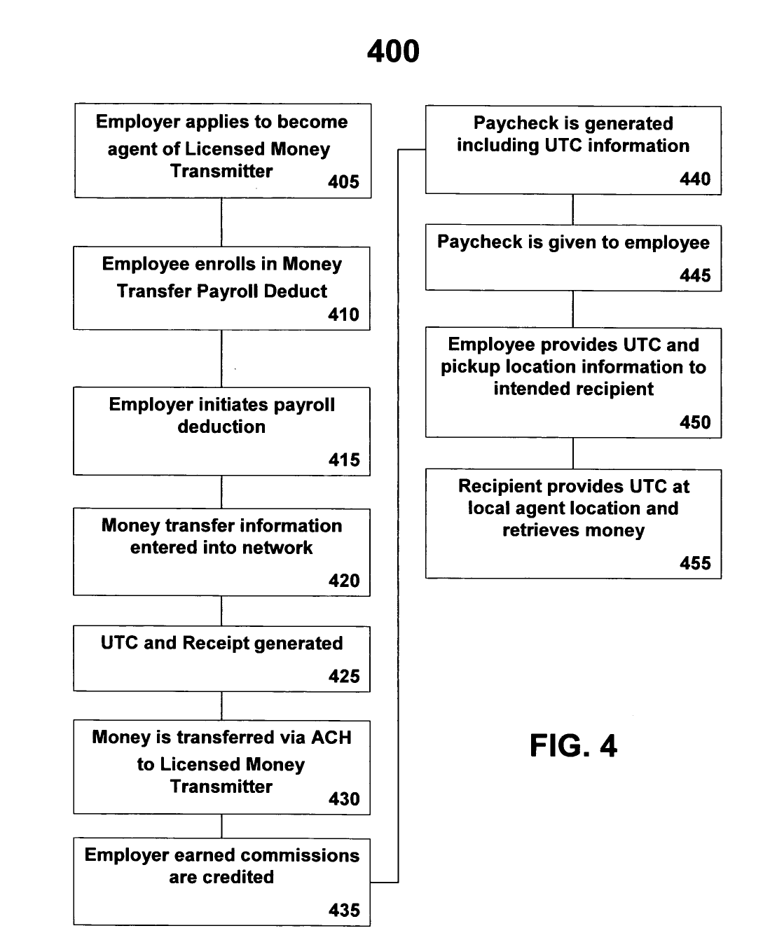

FIG. 4 is a flow chart illustrating an exemplary process for transfer money using payroll deduction and a licensed money transmitter.

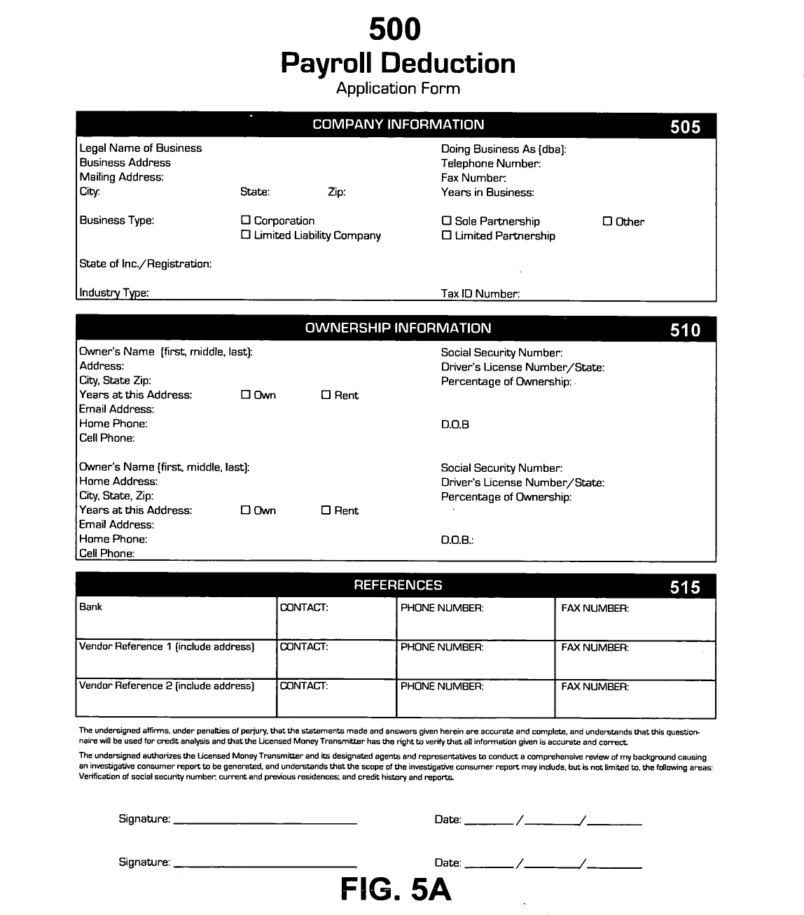

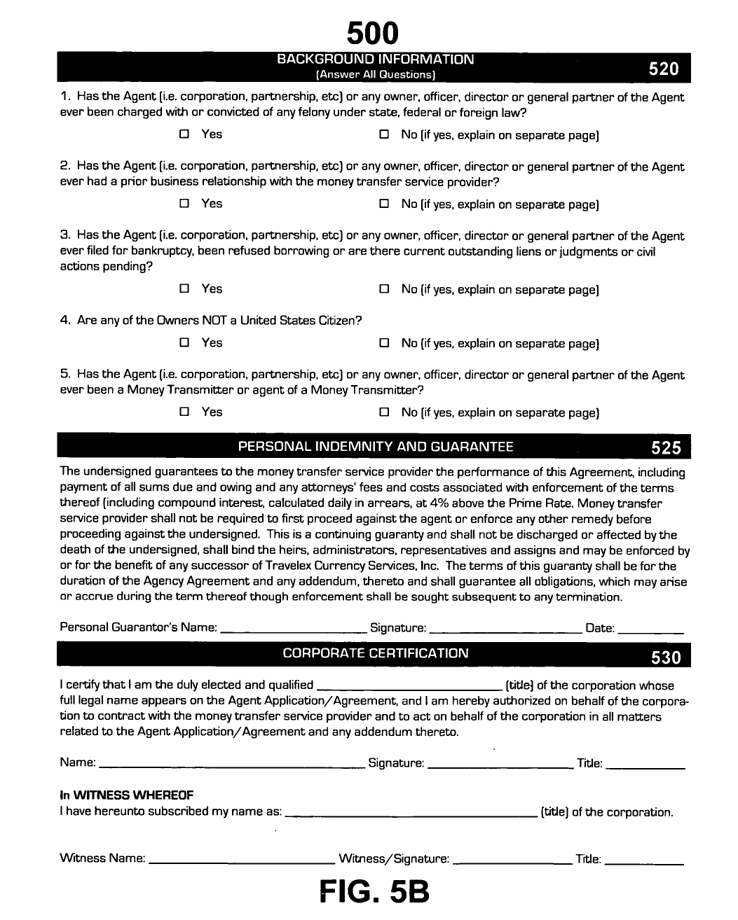

Initially, an employer applies to become an agent of the money transfer provider as indicated in block 405. A sample payroll deduction agent application form 500 is illustrated in FIGS. 5A&B. The Application form may be similar to the form utilized by a licensed money transmitter (LMT) to enroll a new retail agent or the form can be tailored specifically for the enrollment of an employer. In the first section 505 of the application, the employer provides basic information concerning the enterprise such as its name, contact information, entity type and tax ID number. In a second section 510, the employer provides information concerning its ownership. This information will typically not be required when the employer is a publicly traded corporation. In the third section 515, the employer is asked to provide references from its bank, as well, as several vendors with whom it does business. In the fourth section 520, the employer is asked several background questions which pertain directly to the Employer's creditworthiness, financial situation and integrity.

The LMT can utilize the information in these sections to assess the financial condition and credit worthiness of the employer and its principle owners. Based on this information and additional investigation facilitated or necessitated by the provided information, the LMT will determine whether or not to accept the employer as an agent. As will be discussed in greater detail below, a transferred sum of money is typically immediately available to the intended recipient the minute the transaction is submitted to the LMT's server computer and a UTC is returned therefrom. The transactions may be initiated before the money, which has been deducted from the employee's paycheck, has been transferred to the LMT. In such instances, the LMT is effectively extending credit to the employer. Accordingly, it is extremely important to the LMT to know the financial condition of an employer before it makes the employer an agent.

In addition, to deciding whether or not an employer should be an agent, the information provides the LMT with information to determine the type and nature of its relationship with the employer. For instance with an employer that has questionable credit or has yet to establish credit, the LMT may require the employer to maintain an account with the LMT wherein the employer may only transfer money on behalf of employees up to the amount currently in its account. Accordingly, the LMT need not be concerned about the employer failing to make good on money transferred for its employee on credit. Conversely for companies with good credit, the LMT may extend credit to the employer to be settled on a periodic basis. The actual arrangements that the LMT makes with any potential agent employer can be standardized or determined on a case per case basis.

In the fifth section 525, an officer or owner of the employer may be asked to provide a personal guarantee for any amounts of money the LMT has extended to the employer on credit, such as may occur if the LMT affects a transfer for an employee prior to receive the payroll deduction amount from the employer. A personal guarantee will often not be required depending on the particulars of the employer. For instance, an employer that is a publicly traded corporation will typically not be required to have an officer or shareholder sign a personal guarantee.

Finally, in the fifth section 530, a duly authorized agent of an employer that is a corporation signs the application attesting that he/she has the authority to contract with the LMT on behalf of the corporation. This section will often be filled out by an officer of the corporation or at the very least a manager or director having operational responsibility and authority concerning employee payroll and benefits. In certain instances, such as wherein the employer is a Limited Liability Company (LLC), a manager of the LLC may also be asked to attest to his/her authority to legally bind the LLC. Depending on the form and format of the employer, its size, and the requirements of the LMT, the employer may or may not be required to sign both sections four and five 525 & 530. For instance, a personal guarantee will typically not be expected for corporations of sufficient size if they are in good standing, and when the business is a partnership or sole proprietorship, a corporate certification is typically unnecessary.

The Application form is sent to the LMT who reviews the information contained therein and determines whether to accept the employer as an agent, as well as, determining the particulars of the contractual relationship between the employer and the LMT. As discussed above, the nature of the relationship may depend on the size and credit worthiness of the employer as well as other factors (i) provided in the Application and/or (ii) determined from further investigation.

The Employer Application presented in FIGS. 5A&B is merely exemplary and can vary significantly depending on the nature and amount of information a LMT desires from perspective agents. There may also be different application forms for different types of legal entities with the requested information tailored to the particulars of the employer's entity type.

Referring back to FIG. 4, after signing up and being approved as a money transfer agent of the LMT, the employer offers the money transfer via payroll deduction service to its employees as an employee benefit. Typically, the LMT will provide the employer with marketing materials aimed at providing the employees with information about the service and its potential benefits. The marketing materials can comprise brochures, paycheck stuffers and signage. The marketing materials can also be made available in languages other than English. For instance, marketing materials written in Spanish are likely to be provided to employers that have a large Latin American workforce.

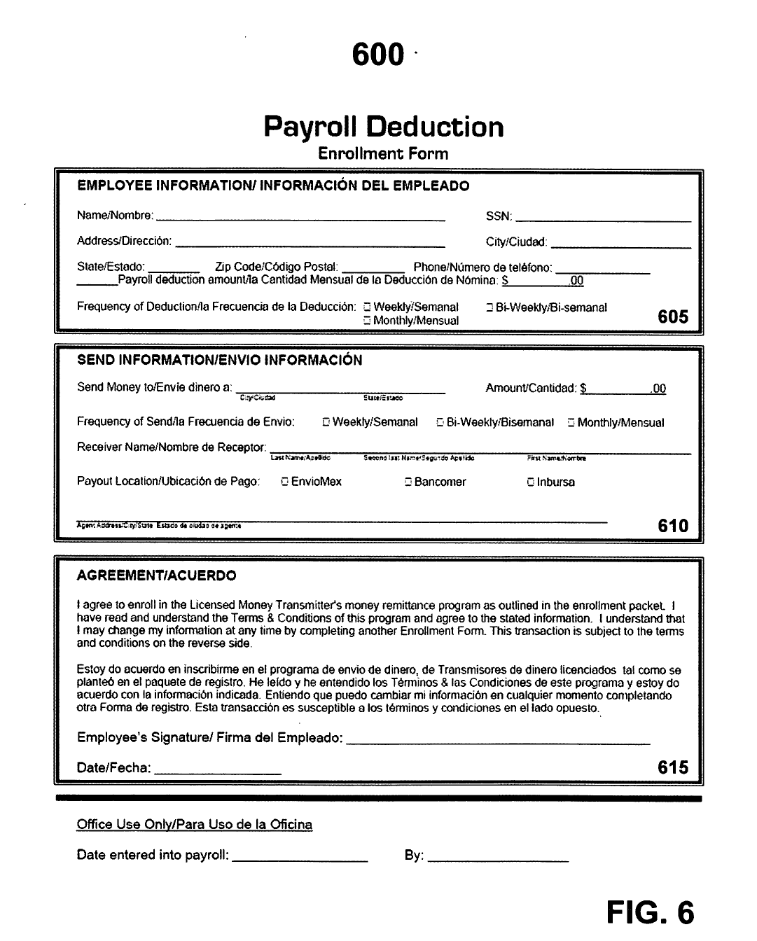

When an employee desires to participate in the payroll deduction money transfer program, he first fills out an enrollment form to enroll in the program as indicated in block 410. An exemplary Enrollment Form is illustrated in FIG. 6. In the first section 605, the employee provides his/her name, address, and telephone number. Additionally, the employee provides the amount of money he/she wants deducted from his/her paycheck including how often the employee wants the money deducted from his/her paycheck. The frequency may depend on how often the employee is paid. For instance, if the employee is paid weekly, he/she may be required to have a deduction made every week, or if the employer permits, the employee may be able to have the desired amount of money deducted every other week or even once a month (i.e. every 4 weeks). However, an employee that is paid every two weeks would obviously not be able to have payroll deducted every week. Further, at the employer's discretion, it may require an enrolled employee to transfer money with each paycheck rather than permit the employee to request a money transfer at longer intervals.

In the second section 610, information concerning the intended recipient is typically provided including the recipient's name, the amount to be sent to the recipient, the frequency of the transfers to the intended recipient, and the location where the money will be transferred as well as the payout location. As shown, the payout location can be EnvioMex, Bancomer or Inbursa, which can be agents of the LMT in Mexico. For transfers to different countries the form can vary to indicate the agents in the various locals within the country or blank spaces can be provided for the employer to reference an agent database of the LMT to determine the proper agent and the agent's address within a particular locale. In other instances, the employee can be prompted to call a customer service number (which can be toll free) to obtain the name and address of an agent closest to the location of the intended recipient. In yet other instances, the LMT may determine the closest agent to the intended recipient once the enrollment information is entered into the LMT's database and inform the employer and the employee thereafter.

The Enrollment Form 600 only contemplates a single intended recipient. It is appreciated that an employee may be permitted to indicate more than a single recipient by preparing multiple enrollment forms or alternative enrollment forms can be provided that permit more than a single recipient. The number of intended recipients to whom an employee may send money and the frequency of which he sends money to each recipient is typically determined at the discretion of the employer who must enter the transaction information for each transfer into the LMT's network. In some instances, because of the cost in manpower to administer the program, the employer may limit the number of recipients the employee may transfer money to, as well as, the frequencies of which the money can be transferred. In other instances, the employer may permit the employee to freely choose how and when money from his her paycheck is to be transferred.

In the third section 615, a space is provided for the employee to sign the Enrollment Form and agree to the terms and conditions concerning the transfer of the LMT. The terms and conditions are relatively standard in the money transfer industry.

The Enrollment Form 600 as illustrated, which is intended primarily for senders from Latin America, is written in both English and Spanish so that non-English speaking employees can read and understand the document. Alternative forms can be provided in English only or in other languages as well.

After receipt of the enrollment form, the employee's information is typically entered into the LMT's database by the employer. In certain embodiments, the LMT may provide certain benefits to the employee, such as enrollment in a frequent user program which speeds up the employees transfer transactions when using retail agent locations as well as offers a reduction in the time it takes a retail agent to complete a transaction. Simply, when an employee is enrolled in embodiments of the program, he/she is typically assigned a unique identifier and an agent of the LMT need only provide that unique identifier to the LMT network to pull up all the information relating to the employee pertinent to a money transfer. As can be appreciated, entering the information concerning the employee into the LMT network database eliminates the need for a payroll agent of the employer to enter the information in to the LMT network for each and every money transfer.

In certain embodiments, the company may not want to have information concerning its employees retained in the LMT's network database under a unique identifier and accordingly, the employer need not enter the employee information into the network database at the time of enrollment. Rather, the employer may make a notation in its employee files or records, which can be maintained on an employer computerized database related to the employer's payroll processing that causes the employer's agents to enter a particular employee's information into the LMT's network each and every time a specific money transfer is initiated.

Referring to block 415 and 420 of FIG. 4, prior to an employee's payday, a payroll processor of the company logs onto the LMT's network and initiates a money transfer to the employee's desired recipient(s) as indicated on the employee's Enrollment Form 600. The processor enters the employee's information, which may simply comprise the employee's unique identifier, into a money transfer request on the network. Once the unique identifier is entered, the LMT's server will pull the information associated with the unique identifier such as the employee's name and contact information. The system may also have information concerning the employee's preferred recipient(s) and the amounts typically transferred to the recipient(s). The processor enters the pertinent information concerning the transfer into the system and/or verifies the information provided by the server and makes changes as necessary. Once the information is verified as correct the processor submits the transfer request to the LMT and the transaction is automatically processed. In variations, the LMT may enter the necessary information concerning the transaction into the LMT's server upon receipt of the appropriate information from the employer.

As indicated in block 425, a UTS is generated by the LMT's server. Generally, contemporaneously with the generation of the UTS, the LMT server makes the money available to the intended recipient at the agent location indicated on the transfer request upon presentation of the UTS. The employer agent's account with the UTS is debited and the account of the dispensing agent is credited within the server. The actual transfer of the money via ACH or some other money transfer protocol may occur simultaneously with each transaction or may combined with other transactions relating to the employer and assessed on a periodic basis. Similarly, the actual transfer of money to the dispensing agent can be simultaneous with the particular transfer or combined with other transfers and sent to the agent's bank account on a periodic basis. Nevertheless, the money is available to the recipient almost at the dispensing agent contemporaneously with the generation of the UTS, such that the minute an employee receives the UTS he can contact the recipient and give him/her the UTS and the money will be available for the recipient regardless of whether the actual transfer of money has occurred. The accounting of the money is a separate matter to be handled pursuant to contracts between the LMT and its agents.

To effect the transfer of money from one country to another, the LMT upon receipt of the request, the LMT's server queries financial databases to which it is connected to determine the relevant exchange rate between the currency type that is being transferred and the currency type that will be received by the recipient. The LMT's servers then calculates the actual amount of money in the recipient's currency that is to be received by the recipient based on the amount of money in the employee's currency that is being transferred to the recipient. The fee for the transfer service to be assessed the employee and withheld from the employee's paycheck is also determined. The fee typically comprises two components: a fixed service fee charged by the LMT; and a variable foreign exchange margin on the exact amount transferred. In transactions to Mexico for instance the LMT may charge a $10 service fee for any transfer up to a predetermined maximum, such as $1,000. Further, the foreign exchange margin, which typically is a small percentage of the entire transaction will also be assessed based only on the exact amount transferred.

In yet other embodiments, the LMT's network can be connected with the employer's payroll processing database for the limited purpose of querying the employer's payroll system database each payroll period to determine which employees are transferring money and where each employee is transferring money. Accordingly, the LMT information system can automatically generate a UTS for the related transfer and provide the necessary information to the employer for inclusion with the employee's paycheck. In one variation, the UTS can be provided electronically to the employer's employee payroll system to be imprinted on the employee's payroll stub. In other variations, paper receipts containing the UTS can be provided to the employer for inclusion with the employee's paycheck information.

Referring back to FIG. 4, in block 430, the money to be transferred by the employee along with any related fees and charges is transferred from the employer's bank account to a bank account of the LMT typically using ACH. In most instances, the ACH transfer from the employer to the LMT will be a single aggregate transfer of a substantial portion if not all of the money being transferred during a given pay period by all the enrolled employees. Although the LMT may perform an ACH transfer relative to each employee transfer in alternative embodiments. Furthermore, in other embodiments, the ACH transfer may occur on a periodic basis, such as monthly, as determined by way of contract between the employer and the LMT. In yet other embodiments, the LMT may bill the employer who then pays the bill as part of its normal bill paying process.

As indicated in block 435, the employer's earned commissions are credited back to the employer. As mentioned above, the employer earns a commission for each transfer much like a retail agent earns a commission on each transaction. The fees earned can be paid or credited to the employer in any number of ways including a reduction in the amount payable to the LMT, i.e. the employer only transfers to the LMT the amount transferred by its employees plus the fees and charges assessed from the transfer minus its commissions. In other variations, the entire amount of money transferred and the fees in full are wired via ACH to the LMT and the LMT sends the employer a commission amount on a periodic basis. In yet another variation wherein the employer desires to pass on the savings related to the commission all or in part to the employees using the service, the employer may negotiate with the LMT to have the fees assessed to the employees further reduced in lieu of the employer receiving a commission.

As typically done each pay period, an employee paycheck or employee pay information (when automatic deposit is utilized) is generated, which states the employee's gross earnings along with any deductions made to those earnings. The deductions will include the amount of money transferred and the fees associated with the transfer. The paycheck or paystub is provided to the employee along with a UTS for each money transfer made by the employer for the employee as indicated in block 445. In some variations, the UTS will be printed directly onto the paycheck and in other variations, the UTS will be provided separately along with a receipt from the LMT. While an employee's paycheck or paystub is typically and customarily provided to the employee in paper form, it is appreciated that a paystub may also be provided to the employee in electronic form, such as by way of email presumably over a secure connection, or any other suitable form. The UTS may also be provided to the employee via alternative means as long as the UTS is not readily or easily accessible to those other than the employee.

Next, as indicated in block 450, the employee notifies the recipient that money is available for pick up at the predetermined LMT agent location and the employee provides the recipient with the UTS. Finally, the recipient retrieves the money from the local agent in the local form of currency by tendering the UTS as indicated in block 455.

A Second Embodiment of a Process of Transferring Money Using Payroll Deduction

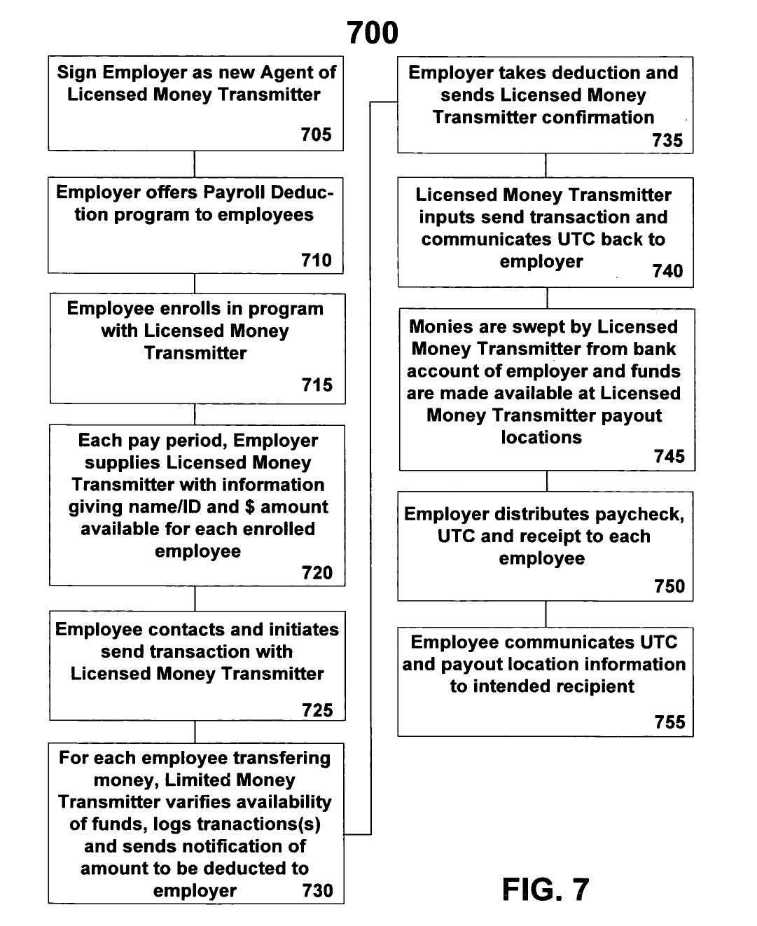

FIG. 7 is a flow chart 700 outlining a second embodiment process of transferring money using payroll deduction. The first embodiment typically, although not necessarily, requires the employee to chose a regular set of recipients and designate the amount of money to be transferred to each recipient on a regular basis. Although employers can permit the employee to make changes to intended recipients and the amounts to be sent to the recipients, they will be generally unlikely to permit changes to be made for each and every pay period: the administrative expense and burden would typically be too great. The second embodiment offers additional flexibility to the employee in determining on a pay period basis to whom and how much money will be transferred.

In a manner similar to described above an employer interested in offering money transfer services to its employees through payroll deduction applies to become an agent of a licensed money transmitter as indicated in block 705. Next, as indicated in block 710, the employer makes the payroll deduction program available to its employees.

The employee in certain variations may enroll in the program by filling out an appropriate enrollment form that is in some respects similar to the enrollment form described above and returning the form to the employer. However, in other variations as indicated in block 715, the employee can be given an enrollment package from the employer that permits the employee to enroll in the program directly with the LMT by: (i) filling out a paper form and mailing it to the LMT directly; (ii) phone providing information to a live representative and/or automated system of the LMT; (iii) computer accessing the internet and providing the requested information over a secure web page; or (iv) any other suitable means as would be obvious to one or ordinary skill in the art. In preferred variations, the LMT can enroll the employee in the LMT's frequent user program that entitles him/her to discounts and/or other benefits that make the money transfer process more convenient and more desirable.

As indicated in block 720, a few days or any suitable time period before payday, information concerning any enrolled employee is provided by the employer to the LMT indicating the amount of money the employee has available to transfer. The available amount can be up to an employee's total net pay or the company may chose to apply limits to the amount that can be transferred each pay period. For instance, the amount that is transferable can be limited to a percentage of the employee's net pay prior to any payroll deductions related to money transfers, or the amount can be limited to a preset amount or limit. The information can be provided to the LMT in any suitable format from an electronic format that the LMT database can parse such as a spreadsheet or other electronic document to a written listing that can be entered into the LMT database by LMT personal.

Next as indicated in block 630, prior to a critical time and date for a particular pay period (such as 2 or more days before payday), the employee is able to telephone the LMT and provide information relating to his/her intended recipients of transferred money, their locations and the amounts to be transferred to each recipient. Alternatively, the employee can: (i) enter the appropriate information onto a webpage and securely transmit the information to the LMT directly; or (ii) relay the information to a retail agent of the LMT.

The LMT then verifies that the amount the employee desires to transfer is within his limit for the current pay period as indicated in block 730. This may be done automatically by referencing the LMT database containing the transfer limits for the applicable employee or the check can be done manually by an agent of the LMT by referring the information provided by the associated employer. The amount to be deducted from the employee's pay is then sent to the employer a specified amount of time before the paychecks are to be processed and issued.

As indicated in block 735 in preferred variations, the employer deducts the aggregate amount to be transferred and any associated fees from the employee's net pay and sends confirmation back to the LMT. It is to be appreciated that where the LMT's server and database are provided access to the employer's payroll processing servers, the confirmation by the employer may be nearly instantaneous. In other variations, the verification may be provided by a payroll processing clerk. In yet other variations, no confirmation is required.

Typically, although not necessarily, after receiving confirmation from the employer the LMT initiates and completes the one or more money transfer transactions associated with the employee as indicated in block 740. UTCs are generated for each money transfer transactions, and are communicated to the employer in a similar manner as described above.

As shown in block 745 and in a similar manner as described above, the amounts associated with the money transfers and the associated fees are periodically transferred from a bank account of the employer to the LMT typically using ACH. However, as discussed above, money can be transferred between the employer and the LMT in any number of suitable ways.

Also similar to the process described above in relation to FIG. 4, the employer gives a paycheck to the employee along with the UTC and a receipt for the money transfer transaction(s) as indicated in block 750, and the employee subsequently provides the UTC to the indented recipient as well as the payout location as shown in block 755. Finally, as shown in block 760 the recipient provides the UTC to the local LMT agent and receives the money.

Alternative Embodiments and Other Variations

The various preferred embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

I claim:

1. A method of an employer administering a money transfer payroll deduction program, the method comprising:
deducting a first amount of money from the periodic compensation of a first employee;
using a licensed money transmitter to make the first amount available at a first remotely located agent of the licensed money transmitter whereat the first amount is available to a first recipient upon providing a first unique transaction code;
receiving the first unique transaction code from the licensed money transmitter;
issuing a first paycheck minus at least the first amount; and
providing the first paycheck and the first unique transaction code to the first employee.

2. The method of claim 1, further comprising deducting fees assessed by the licensed money transmitter for the transfer of the first amount from the periodic compensation of the first employee.

3. The method of claim 1, further comprising receiving a commission associated with the transfer of the first amount.

4. The method of claim 1 wherein said issuing a first paycheck further includes printing the first unique transfer code on the first paycheck.

5. The method of claim 1, further comprising enrolling as an agent of the licensed money transmitter.

6. The method of claim 1, further comprising enrolling one or more employees including the first employee in money transfer payroll deduction program.

7. The method of claim 1, further comprising transferring of at least the first amount to the licensed money transmitter.

8. The method of claim 1, wherein said using a licensed money transmitter to make the first amount available at remotely located agent of the licensed money transmitter comprises:
signing on to a secured network as an agent of the licensed money transmitter; and
providing information relating to the first employee to the licensed money transmitter over the secured network.

9. The method of claim 1, further comprising:
deducting a second amount of money from the periodic compensation of a second employee;
using the licensed money transmitter to make the second amount available at a second remotely located agent of the licensed money transmitter whereat the second amount is available to a second recipient upon the tendering of a second unique transaction code;
receiving the second unique transaction code from the licensed money transmitter;
issuing a second paycheck minus at least the second amount; and
providing the a second paycheck and the second unique transaction code to the second employee.

10. The method of claim 1, further comprising:
deducting a plurality of individually determined amounts of money from periodic compensation of a plurality of additional employees;
using the licensed money transmitter to make the plurality of individually determined amounts available at a plurality of remotely located agents of the licensed money transmitter wherein an amount of the plurality of amounts is available to a recipient of a plurality of recipients upon providing of one of a plurality of unique transaction codes;
receiving the plurality of unique transaction codes from the licensed money transmitter;
issuing a plurality of paychecks wherein an amount of the plurality of amounts is subtracted from each paycheck of the plurality of paychecks; and
providing one of the plurality of paychecks and one of the plurality of unique transaction codes to each employee of the plurality of employees.

11. The method of claim 1, further comprising periodically repeating the method of claim 1 for a plurality of instances.

12. The method of claim 1, wherein the first remotely located agent is located in a country different from a country in which the employer is located.

13. The method of claim 1, wherein the first paycheck comprises an itemization of the periodic compensation of the first employee minus any deductions thereto including the deduction of the first amount.

14. A business method of a licensed money transmitter, the method comprising:
enrolling an employer as an agent of the licensed money transmitter;
enrolling a plurality of employees of the employer in a money transfer program;
based on a plurality of transfer requests generated by the employer, making money available on behalf of each employee of the plurality of employees at an agent of a plurality of agents of the licensed money transmitter, the plurality of agents being remotely located from the employer; and
providing the employer with a unique transaction code for each transfer request of the plurality of transfer requests.

15. The method of claim 14, further comprising repeating on a regular periodic basis said operations of (i) making money available on behalf of each employee, and (ii) providing the employer with a unique transaction code for each transfer request.

16. The method of claim 14, receiving a monetary bank transfer from the employer equivalent to an aggregate amount of money made available and any fees assessed for the transfer requests.

17. The method of claim 14, further comprising, dispensing money at an agent of the plurality of agents to a recipient upon the tendering of the unique transaction code.

18. A business method of a licensed money transmitter, the method comprising:
enrolling an employer as an agent of the licensed money transmitter; enrolling a plurality of employees of the employer in a payroll deduction money transfer program;
receiving from an employee of the plurality of employees a request to transfer a first amount of money out of the employee's pay to an intended recipient in another country;
communicating a first value comprising the first amount to the employer;
making the first amount of money available at a foreign agent of the licensed money transmitter;
communicating a unique transaction code to the employer for the employer to provide with a paycheck of the employee;
through the foreign agent, providing the intended recipient with the first amount of money when the intended recipient provides the foreign agent with the unique transaction code; and
receiving funds from the employer relating to the transfer of the first amount of money.

19. The method of claim 18 further comprising:
receiving confirmation from the employer indicating a deduction has been taken from the employee's pay represented by the first value.

20. The method of claim 18 wherein the first value further comprises money transfer fees assessed by the licensed money transmitter.
